(19) United States
(12) Patent Application Publication
(10) Pub. No.: US 2024/0257127 A1
(43) Pub. Date: Aug. 1, 2024

(54) CONTROLLING TRANSACTION AUTHORIZATION VIA INFLIGHT ENTERTAINMENT SYSTEM WHILE AIRCRAFT IS CONNECTED OR DISCONNECTED FROM GROUND-BASED PROCESSING SYSTEM

(71) Applicant: Thales Avionics, Inc., Irvine, CA (US)

(72) Inventor: Russell William Motz, Melbourne Beach, FL (US)

(21) Appl. No.: 18/102,967

(22) Filed: Jan. 30, 2023

(51) Int. Cl. G06Q 20/40; B64D 11/00

(52) U.S. Cl. CPC G06Q 20/4014; B64D 11/00155

(57) ABSTRACT

A payment processing system receives from a user device at least one message including information identifying user profile information to be associated with a prepaid account, funding source identification identifying a financial source to be used for temporarily funding the prepaid account, and a schedule identifying when the prepaid account is to be used to pay for a purchase. The system sends an account key through the network interface, and generates the prepaid account with a logical association to the account key, the user profile information, the funding source identification, and the schedule. The system determines when a funding rule has become satisfied based on at least the schedule, and responds to determining the funding rule has become satisfied by funding the prepaid account from the financial source identified by the funding source identification.

### FIELD OF THE INVENTION

The present disclosure relates to systems for controlling authorization for passengers to obtain services and/or products via electronic transactions communicated through an inflight entertainment system while the aircraft is connected or disconnected from a ground-based processing system.

### BACKGROUND

In-flight entertainment and connectivity (IFE or entertainment) systems onboard aircraft typically include a satellite communications (SATCOM) system which enables aircraft systems to communicate through satellites and gateways with ground network nodes. Aircraft may also include a WiFi communication system and/or cellular communication system providing off-board connectivity while located at an airport and as an alternative to the SATCOM system. IFE payment systems use these communication systems to forward payment transactions offboard for payment processing by financial institutions. These modes of communication can, however, experience connectivity disruptions which prevent or delay the timely transmission and processing of payments. Connectivity disruptions can result in fraud or other causes of non-payment for services and/or products, or can result in a delayed or lost opportunity to provide service and/or product to passengers. Three types of payment solutions include a first which requires connectivity at all time, a second which requires no connectivity, and a third which operates with or without connectivity

IFE payment solutions which depend on connectivity, typically suspend all sales when unable to connect to the ground and result in lost revenue opportunities during periods of disconnection. IFE payment solutions which do not require connectivity, defer processing of all sales until after a flight and run a higher risk of fraud and/or non-payment than connected payment solutions.

IFE payment solutions which operate while connected and disconnected employ various approaches to allow sales to continue when disconnected. These IFE payment solutions may allow sales up to a set maximum limit or sales up to a prior-known balance of an account held by a customer. Purchases made during no connectivity are then processed as soon as connectivity is reestablished, and represent a lower level of risk of fraud or non-payment than IFE payment solutions which do not require connectivity.

These three existing payment solution approaches are also based on the purchaser presenting a financial instrument at the point of sale. Presentation of the financial instrument can correspond to the manual or electronic entry of payment information of a credit card, debit card, prepaid card, digital bank token, cryptocurrency, or other financial instrument which may or may not be issued and backed by a financial institution. Electronic entry may correspond to use of a magnetic stripe reader, near field communication (NFC) reader, camera for optically scanning or other device to obtain the payment information.

These three existing payment solution approaches, however, have an additional risk element for non-payment and which is related to banking and credit card regulations. These regulations, in an effort to reduce fraud, have implement safeguards which may require a purchaser to provide proof of their identity as the card holder, also known as proof of card-in-hand, to the backing financial institution. These safeguards include receiving and replying to a financial institution's query via phone and/or Internet before a payment transaction is allowed to proceed. In the situation where ongoing authorization of a transaction is interrupted by a loss of connectivity between the on-board IFE payment system and ground-based IFE payment processing system communicating with the financial institution, the purchaser (aircraft passenger and/or crew) may not have access and/or ability to receive and response to a query and which in turn will result in the transaction being declined by the financial institution.

Therefore, to enable increased revenue from collection from sales to aircraft passengers and crew while reducing risk of fraud or non-payment and/or rejection by financial institutions, there is a need to provide an IFE payment solution that can operate with consistent results during flight while in either connected or disconnected off-board communication states. There is further a need for such IFE payment solution to operate without imposing arbitrary sales limits or requirements for prior-knowledge of account balance.

### SUMMARY

Some embodiments of the present disclosure are directed to a payment processing system that includes a network interface, a processor, and a memory storing instructions executable by the processor to receive through the network interface from a user device at least one message. The at least one message includes information identifying user profile information to be associated with a prepaid account, funding source identification identifying at least one financial source to be used for temporarily funding the prepaid account, and a schedule identifying when the prepaid account is to be used to pay for a purchase. The instructions further operate the processor to send an account key through the network interface, and generate the prepaid account with a logical association to the account key, the user profile information, the funding source identification, and the schedule. The instructions further operate the processor to determine when a funding rule has become satisfied based on at least the schedule, and respond to determining the funding rule has become satisfied by funding the prepaid account from the financial source identified by the funding source identification.

Some further embodiments are directed to the payment processing system including an IFE payment processing system and further defining operations which control funding of the prepaid accounts. The funding rule may be determined to have become satisfied based on a current time of day and date being within a threshold time of scheduled departure of an aircraft flight indicated by the schedule during which the prepaid account is available to make on-board purchases. When a message indicates departure of the aircraft flight is delayed a defined delay duration beyond the scheduled departure, the instructions may delay the funding of the prepaid account based on the defined delay duration. Alternatively or additionally, the funding rule may be determined to have become satisfied based on receiving a message through the network interface indicating an aircraft flight identified based on the schedule has departed an airport and further based on the current time of day and date being after the scheduled departure of the aircraft flight. Alternatively or additionally, the funding rule may be determined to have become satisfied based on receiving a message indicating loss of communication connectivity for at least a threshold duration between a ground station and a radio transceiver of the aircraft during the aircraft flight and further based on the current time of day and date being after the scheduled departure of the aircraft flight.

Some further embodiments are directed to further defining operations which control de-funding of the prepaid accounts. A de-funding rule may be determined to have become satisfied based on at least the schedule and, responsive thereto, operation can return at least some funding remaining in the prepaid account back to the financial source identified by the funding source identification. In some further embodiments, operations may determine when the de-funding rule has become satisfied based on a current time of day and date being within a threshold of scheduled arrival of the aircraft flight identified based on the schedule. Operations may determine the de-funding rule has become satisfied based on receiving a message indicating departure of the aircraft flight identified based on the schedule is delayed more than a defined time duration beyond the scheduled departure of the aircraft flight. Operations may determine the de-funding rule has become satisfied based on receiving a message indicating indicating cancellation of an aircraft flight identified based on the schedule.

Potential advantages provided by one or more of these and other embodiments of the present disclosure may include that the prepaid account is temporarily funded during a shorter duration. The funding and/or de-funding of the prepaid account may dynamically follow events associated with flight delays, cancellations, movement of account owners (users or passengers) to other flights, etc. Movement of funds into a prepaid account can thereby be less objectionable to account owners, and who may thereby allow increased threshold level of funding of the prepaid account. Use of a sufficiently funded prepaid account during a flight or other vehicle trip can thereby enable account owners greater freedom to make onboard purchases irrespective or whether a radio transceiver of the aircraft or other vehicle is connected or disconnected from offboard communications.

Other systems and corresponding methods and computer program products according to embodiments of the inventive subject matter will be or become apparent to one with skill in the art upon review of the following drawings and detailed description. It is intended that all such additional systems, methods, and computer program products be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 illustrates electronic components located within an aircraft fuselage which can process payments for onboard purchases and which can communicate with a ground-based IFE processing system in accordance with some embodiments of the present disclosure;

FIG. 2 illustrates a block diagram of components of aircraft systems and ground-based systems which can operate to approve purchase requests in accordance with some embodiments of the present disclosure;

FIG. 3 illustrates example component systems of a PED-based system containing an IFE account access service which communicates through an Internet Service Provider with a ground-based IFE payment processing system in accordance with some embodiments of the present disclosure;

FIG. 4 illustrates a block diagram of processing operations which may be performed by the ground-based IFE payment system on an incoming account creation request from the PED-based system in accordance with some embodiments of the present disclosure;

FIG. 5 illustrates a block diagram of processing operations which may be performed by the ground-based IFE payment system on an incoming request from the PED-base system to establish travel date(s) and to secure temporarily fund for that period of the IFE account in accordance with some embodiments of the present disclosure;

FIG. 6 illustrates a block diagram of processing operations which may be performed by the aircraft-based IFE payment system on in the creation, storage and transmission of the payment transaction requests, containing the IFE account key, for processing by the ground-based Payment Processing System of FIGS. 1 and 2 in accordance with some embodiments of the present disclosure;

FIG. 7 illustrates a block diagram of processing operations which may be performed by the ground-based IFE payment system on an incoming purchase transaction request transmitted by the aircraft-based IFE payment system in accordance with some embodiments of the present disclosure;

FIG. 8 illustrates a representation of the PED-based application to configure the IFE account settings and establish the travel period for which the prepaid account is funded in accordance with some embodiments of the present disclosure;

FIG. 9 illustrates a block diagram of processing operations which may be performed by the ground-based IFE payment system to fund the prepay IFE account for use within the travel period in accordance with some embodiments of the present disclosure;

FIG. 10 illustrates a block diagram of processing operations which may be performed by the ground-based IFE payment system to return any unused balance held in the prepaid IFE account after the travel period has expired period in accordance with some embodiments of the present disclosure; and

FIG. 11 illustrates a block diagram of components of a processing system which may operate as the aircraft based payment system, IFE account access system, and/or passenger electronic device (PED), and/or as the ground-based IFE payment processing system illustrated in other figures according to some embodiments of the present disclosure.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

Various embodiments of the present disclosure are directed to innovative ways for IFE payment solutions to authorize payment transactions during flight with consistency irrespective of whether the IFE system is connected or disconnected from a ground-based payment processing system. These IFE payment solutions may operate without imposing arbitrary sales limits or requirements of prior-knowledge of account balance. Although embodiments herein are primarily described in the context of IFE payment solutions for an aircraft, the invention is not limited thereto. Instead, these and other related embodiments may provide payment solutions for other types of vehicles which can be subject to loss of off-board communication connectivity, including without limitation, ships (e.g., cruise ships), trains, subways, and buses. Moreover, these and other related embodiments may be used in non-vehicle applications, such as sports venues, hotels, and other locations where payment solutions may be subject to intermittent loss of communication connectivity to remote payment processing system(s). Accordingly, although various embodiments are described in the example context of involving passengers and crew, these and other embodiments can more generally be used by any persons (“users” or “account owners”) and by computer equipment which may or may not operate with a person in-the-loop.

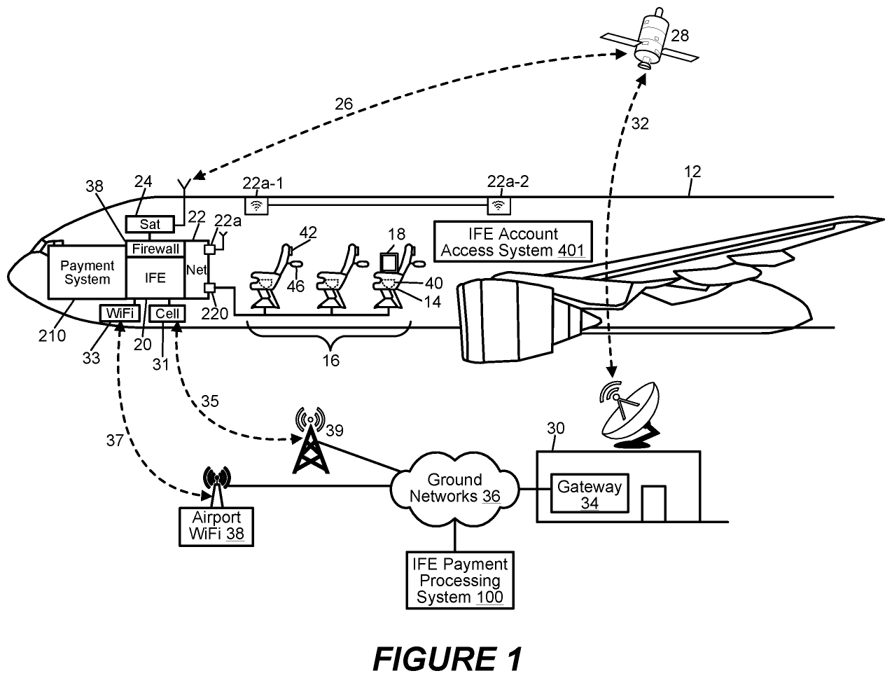

In the context of an IFE payment solution, FIG. 1 illustrates electronic components located within an aircraft fuselage 12 which can process payments for onboard purchases and which can communicate with a ground-based IFE processing system 100 in accordance with some embodiments of the present disclosure. A passenger may utilize a passenger electronic device (PED) 18 or display 42 (e.g., seat video display unit (SVDU)) during flight to communicate with a payment system 210 and IFE account access system 401 to, for example, request to purchase Internet access, premium content (e.g., movies, games, etc.) available on or through an IFE server 20, food and/or drinks, goods, etc. PEDs 18 may be transported onto the aircraft by passengers or may be provided by airline carriers for temporary use during a flight. PEDs 18 can include smart phones, tablet computers, laptop computers, and other devices that include a processor which executes pre-programmed instructions (e.g., airline application or other user application). The displays 42 (e.g., SVDUs) may be mounted to structures within the aircraft, including to seatbacks, seat armrests/frames, bulkheads, overhead structures etc. PEDs and displays 42 are also referred to as user devices since they can serve as an electronic interface operated by passengers, crew, etc. A user device may also be operated without a person in-the-loop.

Operations for payment processing may include the payment system 210 communicating through a satellite network or terrestrial network with the ground-based IFE payment processing system 100 to authorize a transaction relating to an onboard purchase request. However, in accordance with some embodiments of the present disclosure, the payment system 210 is additionally or alternatively configured to authorize the transaction through operations that charge against a prepaid account associated with the passenger, where these operations may be performed while communication connectivity is interrupted between the payment system 210 and IFE payment processing system 100 and/or while payment processing communications are delayed. Delay of payment processing communications may performed according to a defined schedule for purposes of, e.g., temporarily reducing communication network loading and/or performing the communications when communications costs are lower. Lower communication costs can correspond to when communications can be performed through a terrestrial cellular network instead of a satellite network.

The IFE server 20 can be configured to provide various services to the PEDs 18 and/or displays 42 via one or more data communications networks 22, e.g., wired network such as wired Ethernet and/or wireless WLAN access points. The data communication networks 22 can be connected to WLAN access points 22a, 22a-1 and 22a-2 spaced apart within the fuselage 12 to enable communication with WiFi enabled PEDs 18, displays 42, etc. Services offered by the IFE server 20 may include content downloading or streaming (e.g., movies, games, TV programming, digital reading media, etc.), shopping for goods, ordering food and/or services, etc.

The IFE server 20 may also offer Internet access through connecting PEDs 18 and/or displays 42. One contemplated offboard communication modality that may operate with the IFE server 20, when the aircraft is so equipped, uses a satellite communication transceiver 24 to establish and maintain a broadband data communications link 26 with a communications satellite 28. The link 26 may use Ku-band microwave transmissions. However, any suitable communications satellite 28, such as Inmarsat or Iridium may also be utilized without departing from the present disclosure including other bands, such as Ka-band, C-band and/or X-band. The communications satellite 28 maintains a broadband data communications link 32 with a satellite gateway 34 operated by a communications service provider 30. Bidirectional broadband data communications are performed between the aircraft satellite communication transceiver 24 and the ground satellite gateway 34 via the links 26 and 32. The ground satellite gateway 34 is connected to ground networks 36, such as the Internet and/or private networks. There are numerous types of network nodes, e.g., content servers, that are accessible to passengers via the IFE server 20 connected to the satellite 28 and gateway 34. Communications between the payment system 210 and the IFE payment processing system 100 can be routed through the satellite communication transceiver 24, the ground satellite gateway 34, and the ground networks 36 which may include public networks (e.g., Internet) and/or private networks. Satellite communication links are a relatively expensive pathway for data traffic.

A second contemplated offboard communication modality that may operate with the IFE Server 20, when the aircraft is so equipped, uses a cellular communication transceiver 31 to establish and maintain a broadband data communications link 35 with the configured terrestrial ground-based cellular network 39, e.g., 3GPP 5G NR radio network node, while inflight (e.g., direct air-to-ground communications) and/or while the aircraft is located at an airport. Communications between the payment system 210 and the IFE payment processing system 100 are routed through the cellular communication transceiver 31, the cellular network 39, and the ground networks 36.

A third contemplated offboard communication modality that may operate with the IFE Server 20, when the aircraft is so equipped, uses a WiFi communication transceiver 33 to establish and maintain a broadband data communications link 37 with an airport WiFi network 38 when the aircraft is at the airport and connected to the ground networks 36, such as the Internet and/or private networks. Communications between the payment system 210 and the IFE payment processing system 100 are routed through the WiFi communication transceiver 33, the airport WiFi network 38, and the ground networks 36.

In the context of the first offboard communication modality, a PED 18 can connect to the IFE server 20 via one of the WLAN access points 22a, 22a-1, 22a-2 which relays the data transmissions to the satellite communication transceiver 24 for transmission to the communications satellite 28 over the data link 26, and the satellite 28 relays the data to the gateway 34 over the data link 32. The network gateway 34 then routes the transmission to the ground networks 36 which may be public (e.g., Internet) and/or private networks. Data transmissions from network nodes(s) 90 on the Internet to the PED 18 are understood to follow a reverse pathway. Due to the relatively high costs associated with the communications satellite 28, the airline carrier may use a firewall 38 which controls quality of service (e.g., limits bandwidth) provided to data traffic to and from the satellite communication transceiver 24.

Passengers can utilize services offered by the IFE server 20 through individual seat-based equipment which may include a terminal unit 40, the display 42, an audio output 44, and a remote controller (e.g., passenger control unit) 46, and/or through the PEDs 18. Example seats 14 are illustrated arranged in rows 16. For a given row 16 of seats 14, the terminal unit 40 and the audio output 44 are disposed on the seat 14 for which it is provided, but the display 42 and the remote controller 46 may be disposed on the row 16 in front of the seat 14 to which it is provided. For example, the display 42 and the remote controller 46 can be installed on the seatback of the row in front of the seat. This is by way of example only, and other display 42 and remote controller 46 mounting and access configurations such as a retractable arm or the like mounted to an armrest of the seat 14 or by mounting on a bulkhead.

A common use for the display 42 is to display goods and/or services available for purchase on the aircraft. The terminal unit 40 may be paired with the PED 18 to allow communication (e.g., via Bluetooth, WiFi direct, etc.) between the two devices. The PED 18 may act as a point of sales device which processes an application or browser webpage to offer items to a passenger for purchase, and to perform operations in concert with the payment system 210 to process the passenger's selection and complete a sales transaction.

### Funding and De-Funding Prepaid Accounts:

Example operations are now described in further detail for funding prepaid accounts based on various types of funding rules, and where the prepaid accounts can then be used during travel to authorize and track onboard purchases irrespective of whether communication connectivity has been interrupted or lost. Further operations are also described for defunding the prepaid accounts based on various types of de-funding rules being satisfied.

In accordance with some embodiments, a payment processing system operates to receive through a network interface from a user device at least one message comprising information identifying user profile information to be associated with a prepaid account, funding source identification identifying at least one financial source to be used for temporarily funding the prepaid account, and a schedule identifying when the prepaid account is to be used to pay for a purchase. The information can be received, for example, when a user is registering with an airline advantage account, scheduling a trip, waiting at an airport to board a flight, or after boarding. The payment processing system sends an account key through the network interface, e.g., to the user device for storage. The payment processing system generates the prepaid account with a logical association to the account key, the user profile information, the funding source identification, and the schedule. The payment processing system determines when a funding rule has become satisfied based on at least the schedule, and responds to determining the funding rule has become satisfied, by funding the prepaid account from the financial source identified by the funding source identification. During travel, the prepaid account can be used to approve onboard purchases.

The user profile information may include, but is not limited to, a user's name, a user's address, a defined user identifier, a user device identifier, an application identifier for an account payment application (e.g., airline application) hosted on a user device, etc. The funding source identification may correspond to one or more of a credit card, debit card, prepaid card, digital bank token, cryptocurrency, pre-purchased vouchers, pre-purchased tickets, pre-purchased tokens, other pre-purchased chits, and/or other financial instrument which may or may not be issued and backed by a financial institution. The schedule may correspond to a flight schedule, a sequence of flight schedules, a travel duration defined based on date(s) and time(s), etc. This information and the account key are described through further examples below.

The payment processing system can be implemented in the ground-based IFE payment processing system 100 operative to process purchase transactions received from the aircraft-based IFE account access system 401 for users (e.g., passengers and/or crew) onboard the vehicle against prepaid accounts.

Although FIG. 1 illustrates the payment processing system 100 as being ground-based, some or all of the operations described herein for a payment processing system may be performed by the aircraft-based IFE account access system 401. Accordingly, the payment processing system can additionally or alternatively be implemented at least partially in the aircraft-based IFE account access system 401. The aircraft-based IFE account access system 401 is then operative to communicate with a ground-based processing system, e.g., data server, to perform the operations of generating the prepaid account, determining when the funding rule has become satisfied, and funding the prepaid account.

Various example types of funding rules are now explained which can control when funding of a prepaid account is performed, in accordance with some embodiments.

The determination of when the funding rule has become satisfied may be based on a current time of day and date being within a threshold time of scheduled departure of an aircraft flight indicated by the schedule. The prepaid account then becomes available to authorize on-board purchases by the user (account owner) during the flight. The payment processing system may respond to a message indicating departure of the aircraft flight is delayed a defined delay duration beyond the scheduled departure, by delaying the funding of the prepaid account based on the defined delay duration. In this manner, when a flight departure is delayed two hours, funding of the prepaid account can be corresponding delayed two hours to occur closer to the delayed departure. Delaying funding of the prepaid account in this manner to closer in time to when the account owner is traveling onboard the aircraft, can decrease the duration when funds are retained in the prepaid account.

In another embodiment, the payment processing system determines when the funding rule has become satisfied based on receiving a message indicating an aircraft flight identified based on the schedule has departed an airport and further based on a current time of day and date being after a scheduled departure of the aircraft flight during which the prepaid account is available to make on-board purchases. Thus, in a similar manner to the previous example, the prepaid account can be funded based on tracking the account owner's departure on a flight and, thereby, decrease the duration when funds are retained in the prepaid account.

In another embodiment, the payment processing system determines when the funding rule has become satisfied based on receiving a message indicating loss of communication connectivity for at least a threshold duration between a ground station (e.g., satellite gateway 34, cellular network 39, etc.) and a radio transceiver (e.g., transceiver 22, 31, etc.) of the aircraft during an aircraft flight identified based on the schedule and further based on a current time of day and date being after a scheduled departure of the aircraft flight during which the prepaid account is available to make on-board purchases.

Various example types of de-funding rules are now explained which can control when at least some funding remaining in the prepaid account is returned back to the financial source identified by the funding source identification, in accordance with some embodiments.

In one embodiment, the payment processing system determines when a de-funding rule has become satisfied based on at least the schedule, and responds to determining the de-funding rule has become satisfied, by returning at least some funding remaining in the prepaid account back to the financial source identified by the funding source identification. In a further embodiment, the payment processing system operates to delay for a threshold time after determining the de-funding rule has become satisfied, initiation of the return of the at least some of funding remaining in the prepaid account back to the financial source identified by the funding source identification.

In another embodiment, the payment processing system determines when the de-funding rule has become satisfied based on delays until a purchase reconciliation message is received after determining the de-funding rule has become satisfied, operations to initiate the return of the at least some of funding remaining in the prepaid account back to the financial source identified by the funding source identification. The purchase reconciliation message can contain information listing account keys and associated amounts of onboard purchases made by the users against prepaid accounts which are associated with the account keys and managed by the payment processing system.

Purchase(s) made during a flight can be authorized against a funds balance maintained for the prepaid account of the purchaser, and the amount of the purchase(s) can be deducted from the funds balance of the prepaid account.

In one embodiment, the payment processing system operates to receive a transaction message containing information identifying the account key, data contained in the user profile information, and a purchase amount. The payment processing system operates to identify the prepaid account which is logically associated to the identified account key and the data contained in the user profile information, and deduct the purchase amount from a funds balance maintained for the prepaid account. The payment processing system can determine when the de-funding rule has become satisfied based on at least the schedule, and respond to determining the de-funding rule has become satisfied, by returning at least some of funds balance remaining in the prepaid account back to the financial source identified by the funding source identification.

As explained above, in some further embodiments, the payment processing system can determine the de-funding rule has become satisfied based on a current time of day and date being within a threshold of a scheduled arrival of the aircraft flight identified based on the schedule.

A sufficiently lengthy delay or cancellation of the scheduled flight can trigger the payment processing system to automatically operate to returning at least some of funds balance remaining in the prepaid account back to the financial source identified by the funding source identification.

For example, in one embodiment, the payment processing system can determine the de-funding rule has become satisfied based on receiving a message indicating departure of an aircraft flight identified based on the schedule is delayed more than a defined time duration beyond a scheduled departure of the aircraft flight.

In another embodiment, the payment processing system can determine the de-funding rule has become satisfied based on receiving a message indicating indicating cancellation of an aircraft flight identified based on the schedule.

In another embodiment, the payment processing system can determine the de-funding rule has become satisfied based on receiving a message indicating reestablishment of communication connectivity for at least a threshold duration between a ground station (e.g., satellite gateway 34, cellular network 39, etc.) and a radio transceiver (e.g., transceiver 22, 31, etc.) of the aircraft during an aircraft flight identified based on the schedule and further based on a current time of day and date being after a scheduled departure of an aircraft flight identified based on the schedule.

Operations are now describe which may be performed by the IFE account access system 401 in combination with the payment system 210 to authorize and process onboard purchases against prepaid accounts.

Although the IFE account access system 401 and the payment system 210 are illustrated as separate components in FIG. 1, the operations which are described herein for one may be at least partially performed by the other. The systems 401 and 210 may be a single component. Various example embodiments are therefore described in the context of an aircraft-based prepaid account access system which may correspond to the IFE account access system 401 and/or the payment system 210.

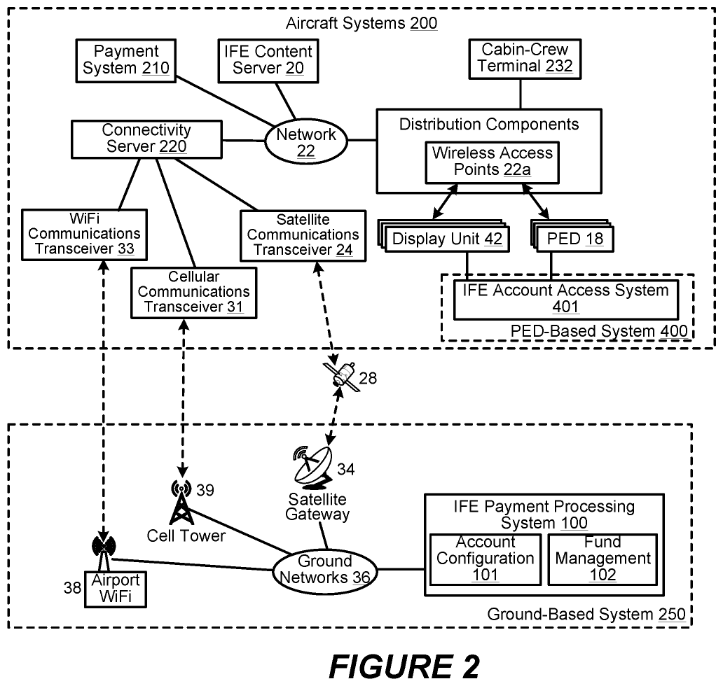

The aircraft-based prepaid account access system operates to communicate with the IFE payment processing system 100 offboard the vehicle to receive a set of prepaid account balances logically associated with account keys. The IFE payment processing system 100 has logically associated the set of prepaid account balances and account keys with a corresponding set of user profile information, funding source identification, and schedule. The aircraft-based prepaid account access system operates to receive a transaction message from a user device (e.g., PED 18, terminal 40 and display 42, crew terminal 232 in FIG. 2), etc.) onboard the aircraft requesting a purchase. The transaction message contains information identifying one of the account keys, data contained in the user profile information, and a purchase amount. The aircraft-based prepaid account access system operates to determine whether the purchase amount is greater than the prepaid account balance logically associated with the identified account key and the data contained in the user profile information. Responsive to when the purchase amount is determined to be greater than the prepaid account balance, the aircraft-based prepaid account access system sends, e.g., to the user device, a declined transaction message indicating the purchase is declined. In contrast, responsive to when the purchase amount is determined to be less than the prepaid account balance, the aircraft-based prepaid account access system deducts the purchase amount from the prepaid account balance and sends to the user device an accepted transaction message indicating the purchase is approved. Also, responsive to when the prepaid account balance logically associated with an underfunded one of the account keys becomes less than a defined threshold, the aircraft-based prepaid account access system communicates a funding request message containing the underfunded one of the account keys to the IFE payment processing system 100.

In some further embodiments, the aircraft-based prepaid account access system determines when a funding rule has becomes satisfied based on at least a travel schedule of the vehicle, and responds to determining the funding rule has become satisfied, by communicating with the IFE payment processing system 100 to initiate funding of the prepaid account balances from the logically associated funding source identification.

In a further embodiment, the aircraft-based prepaid account access system determines the funding rule has become satisfied based on a current time of day and date being within a threshold time of a scheduled flight determined based on the schedule during which the prepaid account is available to make on-board purchases.

In a further embodiment, the aircraft-based prepaid account access system determines the funding rule has become satisfied based on receiving a message indicating loss of communication connectivity for at least a threshold duration between a ground station and a radio transceiver of the aircraft during flight.

In a further embodiment, the aircraft-based prepaid account access system determines when a de-funding rule has become satisfied based on at least a travel schedule of the vehicle determined based on the schedule, and responds to determining the de-funding rule has become satisfied, by communicating with the IFE payment processing system 100 to initiate return of at some of the prepaid account balance back to a financial source identified by the funding source identification.

In a further embodiment, the aircraft-based prepaid account access system determines the de-funding rule has become satisfied based on a current time of day and date being within a threshold time of an end of the travel schedule of the vehicle determined based on the schedule.

In a further embodiment, the aircraft-based prepaid account access system determines the de-funding rule has become satisfied based on receiving a message indicating reestablishment of communication connectivity for at least a threshold duration between a ground station and a radio transceiver of the vehicle during travel of the vehicle.

These and other related operations are now described in further detail with reference to FIGS. 2 through 10.

FIG. 2 illustrates a block diagram of components of aircraft systems 200 and ground-based systems 250 which can operate to approve purchase requests in accordance with some embodiments of the present disclosure. Referring to FIGS. 1 and 2, the IFE account access system 401 operates to securely store data, which may include an IFE account key (key associated with a prepaid account) and an indication of a schedule (e.g., travel period, flight number(s), etc.) during which a prepaid account is to be funded to enable onboard (inflight) purchases during the travel. The account access system 401 account access system 401 communicates with the payment system 210 to verify existence of the passenger's prepaid account and that a sufficient funds balance exists to authorizing an onboard purchase. The IFE account access system 401 may include a payment application which is hosted by the PED 18 and/or the terminal 40 in combination with the display 42, and operates to generate inflight purchase transaction requests for authorization.

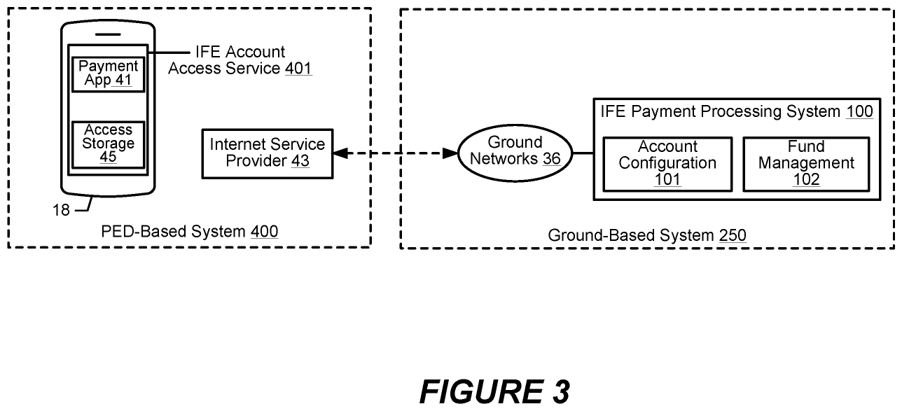

For example, FIG. 3 illustrates a block diagram of a PED-based system 400 communicating with the IFE payment processing system 100 of the ground based system 250 to configure and maintain IFE account settings for use in authorizing inflight purchases. The IFE account assess system 401 includes a payment app 401 which can be hosted on a PED 18 and operate to communicate through a connectivity server 220 (FIG. 2) and one of the communication transceivers 24, 31, 33 and a public network (e.g., Internet service provider 43) and/or private network with the IFE payment processing system 100 of the ground-based system 250. The PED 18 stores an IFE account key (also “account key” and “prepaid account key”) in a local access storage 45 (e.g., local non-volatile memory) previously configured by the IFE payment processing system 100, e.g., at the time of prepaid account creation. The IFE account key is provided by the payment app 41 to the IFE payment processing system 100 when the IFE account holder (e.g., passenger) desires to interact with an IFE account configuration repository 101 to change account settings and/or when a purchase transaction request is made to authorize a purchase. A fund management module 102 is operative to communicate with a financial institution, e.g., credit card account provider etc., to temporarily fund a prepaid IFE account tracked by the account configuration repository 101 for use to use for inflight purchases.

Various embodiments of the present disclosure are directed toward operations for setting-up a prepaid IFE account, temporarily funding the prepaid IFE account from a passenger's financial source (e.g., financial institution), accounting for inflight purchases authorized for payment against the prepaid IFE account using the aircraft-based IFE account access system 401 and payment system 210, and automatically returning residual funds from the prepaid IFE account back to the passenger's financial source. The prepaid IFE account may be funded before the associated account owner has boarded the aircraft and may be de-funded after the account owner has departed the aircraft, so the term account owner is used interchangeably to refer to a user, passenger, and account requestor.

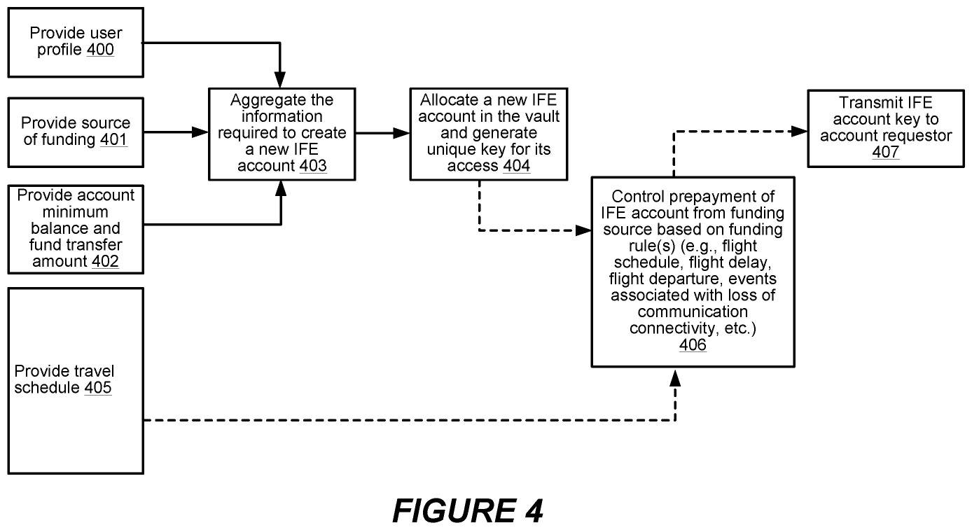

FIG. 4 illustrates a block diagram showing information which is provided through an account requestor's PED 18 and used to setting-up a prepaid IFE account. The information can include user profile 400 information (e.g., including name, address, email address, and/or telephone number), and funding source identification 401 for a financial account or other source to be used for temporarily funding the prepaid IFE account (e.g., credit card, debit card, bank token, cryptocurrency, or other). The information may include information 402 identifying a prepaid IFE account minimum balance and fund transfer amount that is to be used when temporarily funding the prepaid IFE account. The provided information can be aggregated, e.g., logically associated, to create 403 a new prepaid IFE account.

In a further optional operational step, at the time the IFE account is created 403 or thereafter, a travel related schedule can be provided 405 which indicates when the account owner may make purchases while traveling and, therefore, during which the prepaid IFE account is to be temporarily funding. In a further subsequent operation, residual funds from the prepaid IFE account can be automatically returned to the indicated 401 source of funding responsive to completion of travel as indicated by the travel related schedule and/or occurrence of another defined event, e.g., obtaining information indicating completion of last or only leg of flight (e.g., scheduled arrival time and date, indication of flight completion, indication of plan arrival at airport, indication of plane arrival at gate, etc.).

A unique IFE account key is generated and used to securely store 404 the IFE account information (e.g., user profile information, the funding source identification, and the travel schedule) in a secure vault. The IFE account information may, for example, be securely encrypted during storage using the IFE account key. The operation to pre-fund the IFE account 406 can be performed responsive to a funding rule becoming satisfied, which as described above, may be based on the travel schedule defined in the IFE account information. A copy of the IFE account key is transmitted 407 to the requesting user device, e.g., PED 18, where it is securely stored, e.g., in the access storage repository 45. The IFE account key guarantees that the private IFE account information stored in the secure vault is only accessible through the ground-based system 250 when that IFE account key is passed back from the PED 18 as part of a transaction request provided for authorization of a purchase onboard the aircraft through the IFE account access system 401 and the payment system 210.

Some further embodiments are directed to performing a trade compliance check as part of the operations for creating 403 the IFE account. Requirements can arise for a trade compliance check to be performed on the purchase of Internet sales each time such purchase is made. The trade compliance check and require that the system(s) to capture the person's address for both pre-flight purchases as well as in-flight purchases. However, problems can arise in that some International Air Transport Association (IATA) standards that discourage requiring collection of addresses. This is especially true when airline partners, such as Expedia, are making the sale in conjunction with boarding passes.

In accordance with these further embodiments, at the time that the account requestor (user) registers for a new IFE account, operations execute the trade compliance check as a prescreening instead of each time that user makes a purchase. The operations may prescreen users relating to present or future purchases which would require a trade compliance check. These operations for trade compliance checking may or may not be limited to Internet service sales.

In some additional or alternative embodiments, the trade compliance check may be performed as part of a user's first Internet purchase transaction. The trade compliance check operations may be repeated responsive to, e.g., the address in the account being updated and/or when requested to be reverified by the account owner. The trade compliance check operations may be performed responsive to a reverification schedule, responsive to expiration of a period of time from a last check, and/or responsive to a predetermined number of purchases having been made.

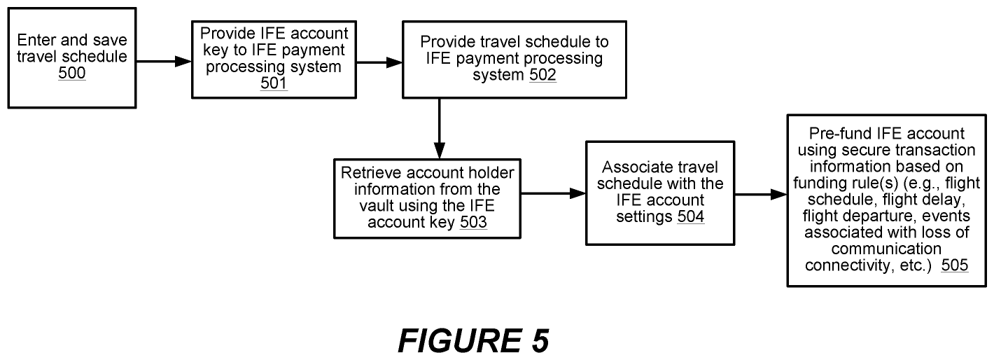

FIG. 5 is a block diagram illustrating operations for entering and using a travel schedule to control funding of the prepaid IFE account, in accordance with some embodiments. The account owner can use the PED payment application 41 to enter and save 500 the travel schedule on the PED 18. The IFE account key 501 obtained according to operations of FIG. 4 is also stored on the PED 18. The IFE account key is provided 501 to the ground-based IFE payment processing system 100 through the ground networks 36 to enable access to content of the prepaid account. The travel schedule is also provided 502 to the ground-based IFE payment processing system 100 through the ground networks 36. The travel schedule and IFE account key can be communicated in a same message. The IFE payment processing system 100 retrieves (extracts) 503 the IFE account key from the message and uses the IFE account key to retrieve account owner (user) information from the account configuration 101 vault. The account owner information can include the IFE account identifier which can correspond to the actual account number. The IFE account identifier is used to associate 504 the travel schedule with the account settings stored in memory, e.g., a repository for fund management 102, of the IFE payment processing system 100 or other data storage. The identified IFE account is pre-funded 505 responsive to the funding rule(s) becoming satisfied based on the schedule, such as according to one or more of the embodiments described above.

In some embodiments, the identified IFE account is pre-funded 505, by the fund management 102 module of the IFE payment processing system 100, a threshold time before a trip (e.g., flight) is indicated by the flight schedule to begin. Operations to pre-fund 505 the identified IFE account may respond to delay of a start of the trip, e.g., flight delay, by correspondingly delaying pre-funding of the identified IFE account. Responsive to determining that a flight of the trip is delayed more than a threshold time in the future or the person is re-booked on another flight to begin more than a threshold time in the future, the operations may correspondingly delay pre-funding of the identified IFE account, e.g., until the threshold time before the delayed flight or re-booked flight is indicated to begin. In some further embodiments, the operations may automatically return at least some of the amount of the pre-funding or residual funds from the prepaid IFE account back to the passenger's financial account responsive to determining the scheduled flight is delayed more than a threshold time in the future, the person is re-booked on another flight to begin more than a threshold time in the future, and/or the flight or trip is cancelled without rescheduling to another time and/or date in the future satisfying a reschedule rule.

Some further embodiments of the present disclosure are directed toward operations for processing the purchase of items on the aircraft, while within the scheduled period(s) of travel, using the aircraft-based IFE payment system 200 and can be validated by the PED-based IFE account access system 401. Items selected by the account owner and contained by the aircraft-based IFE payment system 200 are presented for payment and to use the pre-funded IFE account. The aircraft-based payment system, paired with the account owner's PED 18, requests verification that a valid IFE account exists and is configured for use at the time of sale. When valid, the transaction is submitted for transmission to the ground-based IFE payment processing system 100 for processing.

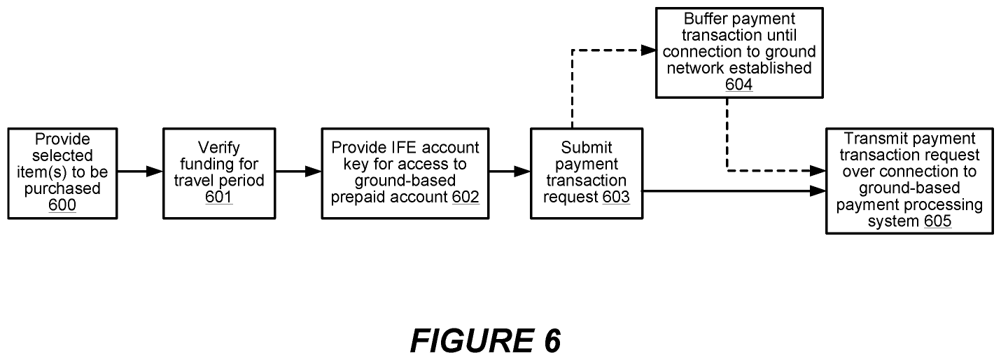

FIG. 6 illustrates a block diagram of processing operations which may be performed by the aircraft-based IFE payment system on in the creation, storage and transmission of the payment transaction requests, containing the IFE account key, for processing by the ground-based Payment Processing System of FIGS. 1 and 2 in accordance with some embodiments of the present disclosure.

Referring to FIG. 6, information is provided 600, e.g., via a purchase transaction request, that identifies a purchase amount, and which can initiate the payment process. The PED-based IFE account access system 401 can be used to verify that the prepaid IFE account is sufficiently pre-funded for use during a defined travel period 601. If within the travel period, the PED-based IFE account access system 401 provides the unique IFE account key to the ground-based prepaid IFE account 602 for use in accessing content of the IFE account. With the IFE account key provided, and validated, the aircraft-based IFE payment system 210 sends the payment transaction request 603 to the connectivity server 220 (FIG. 2). The connectivity server 220 (FIG. 2), if necessary, may buffer the payment transaction until a communication connection to the ground-based IFE payment processing system 100 is established 604. When a communication connection exists, the connectivity server 220 transmits 605 the payment transaction request over the connection to the ground-based IFE payment processing system 100.

Some further embodiments of the present disclosure are directed toward the processing of the purchase transaction request by the ground-based IFE payment process system 100. The purchase transaction request contains the IFE account key which is to be used to access content of the IFE account, including the IFE account prepaid funds. If the request is outside of the travel period (e.g., which may be configured by the account holder and/or the airline carrier), the account balance is zero and the purchase request is denied. Denial of the purchase request will also occur when the transaction has been delayed (e.g., beyond a maximum number of business days) past the end of the travel period. If within the time period, the IFE account is used to pay for the purchase and the account owner can be notified of the use of the funds.

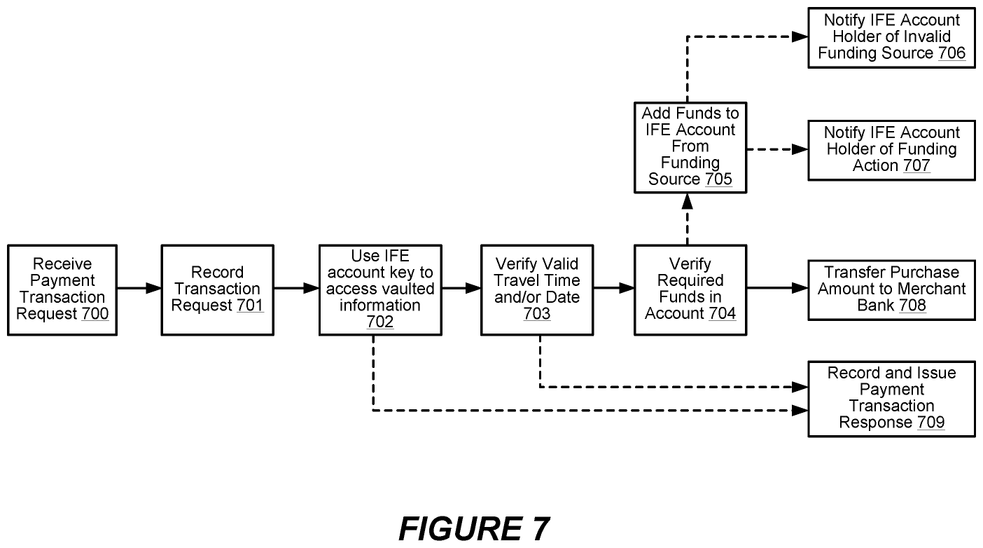

FIG. 7 illustrates a block diagram of processing operations which may be performed by the ground-based IFE payment system on an incoming purchase transaction request transmitted by the aircraft-based IFE payment system in accordance with some embodiments of the present disclosure. The ground-based IFE payment process system 100 receives 700 the purchase transaction request initiated and pre-authorized for use on the current date by the PED-based IFE account access system 410 on the account owners' PED 18. The ground-based payment process system 100 records 710 the reception of the transaction request in a database or other data storage. The system 410 extracts the account holders' unique IFE account key from the transaction request and uses the IFE account key to access 702 content of the IFE account's information stored in the vault. Content of the IFE account information may include the IFE account identifier (e.g., account number), account balance, user profile, account settings, minimum balance funding configuration, and funding amount. Using the IFE account identifier, the system 100 can access the account settings to verify the current date and is a valid travel date 703, and may further verify that a present time of day is within a defined travel time. If present date is valid, the IFE account's prepaid balance is compared to the amount of the purchase to verify that required finds are in account 704. If additional funds are required for the purchase or the use of funds may result in the balance being below a minimum threshold, the system 100 can operate to add 705 funds to prepaid IFE account from the funding source using the funding source identification (e.g., funding source token). If this transfer is required and successful, the system may notify 707 the account holder of the funding action. If the action is not successful the account holder may be notified 706. With sufficient prepaid funds in the account, the system 100 can transfer the purchase amount to merchant bank 708 which is providing the sale the account owner (passenger). For both successful and failed processing of the request, the system 100 can record and may send 709 a payment transaction response back on the account holders' PED 18 for display.

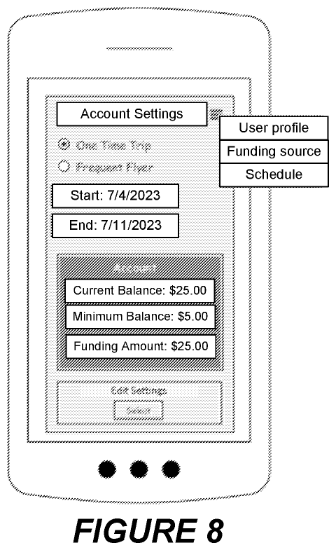

FIG. 8 illustrates a representation of the PED-based application hosted by the PED 18 which operates to configure the IFE account settings and establish the travel period for which the prepaid account is funded in accordance with some embodiments of the present disclosure. Referring to the illustrated example, the IFE account settings can allow a user to define a travel schedule, such as a travel date(s), travel time(s) during a travel date(s), and/or travel periods. The travel schedule may be for a single flight, a round trip, or combinations of trips which may, for example, have defined start and end dates and times. As shown, both a defined period of travel and a current prepaid balance may be displayed. While the current time and date satisfy the defined schedule the prepaid account balance would be funded to satisfy a minimum balance requirement. Otherwise, when outside the defined schedule (e.g., allowing for a defined period of time for reconciliation of records following the trip), the prepaid account balance would be automatically de-funded and therefore shown as zero.

In accordance with various embodiments disclosed herein, the IFE ground-based payment processing system 100 will provide that the IFE account is funded for used in conjunction with the travel period(s) defined by the account holder.

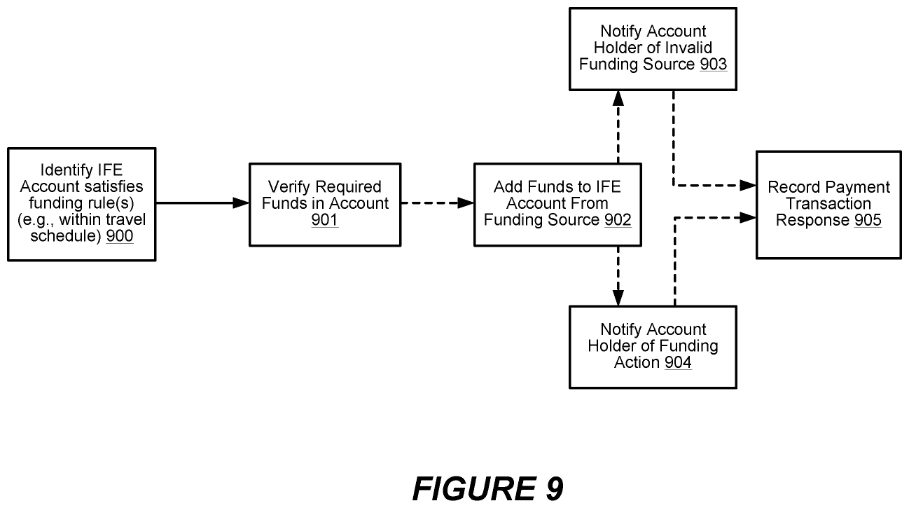

FIG. 9 illustrates a block diagram of processing operations which may be performed by the ground-based IFE payment processing system 100 to fund the prepaid account for use within the travel period in accordance with some embodiments of the present disclosure. The ground-based IFE payment processing system 100 may respond to the funding rule(s) being satisfied by initiating funding of the prepaid IFE account from a user's credit/debit card or funding source that has been identified. As explained above, the funding rule may be any one or more of: 1) becoming within a threshold time of a scheduled flight departure; 2) receiving notification of flight departure; 3) receiving notification of, or determining, loss of communication connectivity with the aircraft; etc. Similarly, the ground-based IFE payment processing system 100 may respond to a defined de-funding rule becoming satisfied by returning remaining funds in the prepaid IFE account or any funds exceeding a defined threshold, back to the user's credit/debit card or other funding source. As explained above, the de-funding rule may be any one or more of: 1) receiving notification of change in flight departure time/date beyond a defined threshold; 2) receiving notification of cancelation of flight; 3) receiving notification of flight arrival; 4) receiving notification of, or determining, re-establishment of communication connectivity with the aircraft; etc. The system 100 may be configured to delay partial or full credit of remaining funds until a threshold amount of time has expired from the defined event triggering crediting in order to, for example, assure that any unprocessed purchases are given time to resolve.

These operations can enable use of prepaid accounts without the usual disadvantages perceived by account owners. Account owner funds are temporarily held in the prepaid account and automatically returned to the account owner promptly after traveling. The system 100 can be configured to temporarily hold the funds for use during a scheduled flight and/or during connecting segments of the flight, and may dynamically react to changing events associated with the user's trip, such as delay and/or cancellation of flight(s).

Operations of the IFE payment processing system 100 include to verify 901 if the prepaid IFE account balance contains funds satisfying account settings. If funds are required, the funding source is used to place 902 funds into the prepaid IFE account and may notify 904 the account holder of the funding action. If the funding source is invalid, the account holder may be notified 903 to take corrective action to maintain the account, e.g., by updating the funding source when the currently identified funding source is invalid. The system 100 may record 905 purchase transactions that are valid and successful and those that are invalid and declined.

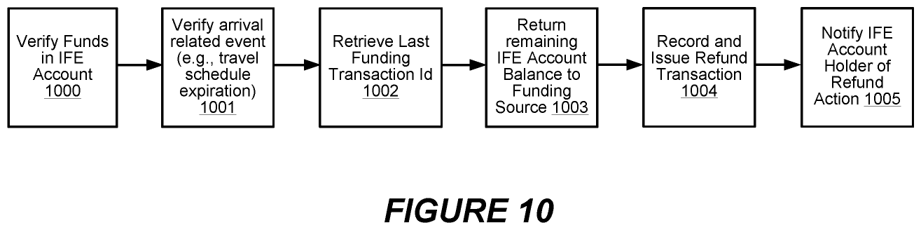

FIG. 10 illustrates a block diagram of processing operations performed by the ground-based IFE payment processing system 100 to return any unused balance. Referring to FIG. 10, the system 100 verifies 1000 the prepaid IFE account contains a balance satisfying account settings and determines 1001 the de-funding rule is satisfied, e.g., the current date and/or time is beyond the travel schedule. Responsive to determining 1001 the de-funding rule is satisfied, the system 100 the last transaction on the IFE account used for funding is identified 1002. The transaction identifier is used to return 1003 to return at least some funding remaining in the prepaid IFE account back to the financial source identified by the funding source identification. The result of the de-funding transaction is recorded 1004 as a refund and the IFE account balance is adjusted to reflect that the account is now de-funded. The account holder may be notified 1005 as to the return of remaining balance to the funding source.

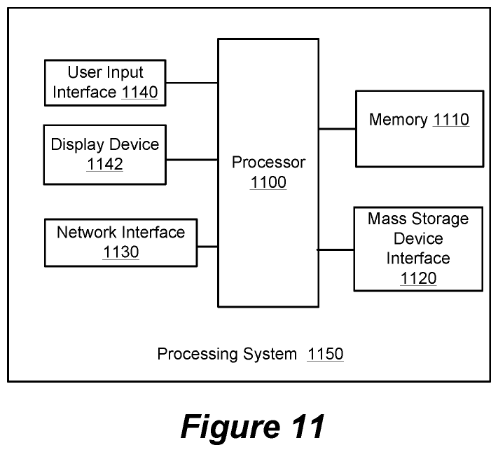

FIG. 11 illustrates a block diagram of components of a processing system 1150 which may operate as the aircraft based payment system 210, IFE account access system 401, and/or the PED 18, and/or as the ground-based IFE payment processing system 100 illustrated in the other figures according to some embodiments of the present disclosure. Referring to FIG. 11, the processing system 1150 includes a processor 1100, a memory 1110, and a network interface 1130 which may include a radio access network transceiver and/or a wired network interface (e.g., Ethernet interface). The network interface 1130 may be configured to communicate through one or more of the networks 22 and 36, and one or more the transceivers 20, 24, 33, 38, 39, 30.

The processor 1100 may include one or more data processing circuits, such as a general purpose and/or special purpose processor (e.g., microprocessor and/or digital signal processor) that may be collocated or distributed across one or more networks. The processor 1100 is configured to execute computer program code in the memory 1110, described below as a non-transitory computer readable medium, to perform at least some of the operations described herein as being performed by an access control computer. The computer program code when executed by the processor 1100 causes the processor 1100 to perform operations in accordance with one or more embodiments disclosed herein for components of the aircraft systems 200 and/or the ground-based systems 250. The processing system 1150 may further include a mass storage device interface 1120 (e.g., repository or database), user input interface 1140 (e.g., touch screen, keyboard, keypad, etc.), and a display device 1142.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an ISP) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A payment processing system comprising:
a network interface;
a processor; and
a memory storing instructions executable by the processor to:
receive through the network interface from a user device, at least one message comprising information identifying
user profile information to be associated with a prepaid account,
funding source identification identifying a financial source to be used for temporarily funding the prepaid account, and
a schedule identifying when the prepaid account is to be used to pay for a purchase;
send an account key through the network interface;
generate the prepaid account with a logical association to the account key, the user profile information, the funding source identification, and the schedule;
determine when a funding rule has become satisfied based on at least the schedule;
respond to determining the funding rule has become satisfied, by funding the prepaid account from the financial source identified by the funding source identification.

2. The payment processing system of claim 1, wherein the network interface, the processor, and the memory are part of a networked server operative to process purchase transactions received through the network interface from a vehicle-based account access system for users onboard the vehicle against prepaid accounts.

3. The payment processing system of claim 1, wherein the payment processing system comprises a vehicle-based prepaid account access system operative to process purchase requests for users onboard the vehicle, wherein the vehicle-based account access system is operative to communicate through the network interface with a ground-based static server to perform the operations of generating the prepaid account, determining when the funding rule has become satisfied, and funding the prepaid account.

4. The payment processing system of claim 1, wherein the payment processing system comprises an InFlight Entertainment (IFE) payment processing system, and wherein the instructions further operate the processor to:
determine when the funding rule has become satisfied based on a current time of day and date being within a threshold time of scheduled departure of an aircraft flight indicated by the schedule, the prepaid account becoming available to authorize on-board purchases by the user during the flight.

5. The payment processing system of claim 4, wherein the instructions further operate the processor to:
respond to a message received through the network interface indicating departure of the aircraft flight is delayed a defined delay duration beyond the scheduled departure, by delaying the funding of the prepaid account based on the defined delay duration.

6. The payment processing system of claim 1, wherein the payment processing system comprises an InFlight Entertainment (IFE) payment processing system, and wherein the instructions further operate the processor to:
determine when the funding rule has become satisfied based on receiving a message through the network interface indicating an aircraft flight identified based on the schedule has departed an airport and further based on a current time of day and date being after a scheduled departure of the aircraft flight during which the prepaid account is available to make on-board purchases.

7. The payment processing system of claim 1, wherein the payment processing system comprises an InFlight Entertainment (IFE) payment processing system, and wherein the instructions further operate the processor to:
determine when the funding rule has become satisfied based on receiving a message indicating loss of communication connectivity for at least a threshold duration between a ground station and a radio transceiver of an aircraft during an aircraft flight identified based on the schedule and further based on a current time of day and date being after a scheduled departure of the aircraft flight during which the prepaid account is available to make on-board purchases.

8. The payment processing system of claim 1, wherein the instructions further operate the processor to:
determine when a de-funding rule has become satisfied based on at least the schedule; and
respond to determining the de-funding rule has become satisfied, by returning at least some funding remaining in the prepaid account back to the financial source identified by the funding source identification.

9. The payment processing system of claim 8, wherein the instructions further operate the processor to:
delay for a threshold time after determining the de-funding rule has become satisfied, initiation of the return of the at least some of funding remaining in the prepaid account back to the financial source identified by the funding source identification.

10. The payment processing system of claim 8, wherein the instructions further operate the processor to:
delay until a purchase reconciliation message is received after determining the de-funding rule has become satisfied, initiation of the return of the at least some of funding remaining in the prepaid account back to the financial source identified by the funding source identification, wherein the purchase reconciliation message contains information listing account keys and associated amounts of purchases made by the users against prepaid accounts which are associated with the account keys and managed by the payment processing system.

11. The payment processing system of claim 1, wherein the payment processing system comprises an InFlight Entertainment (IFE) payment processing system, and wherein the instructions further operate the processor to:
receive a transaction message containing information identifying the account key, data contained in the user profile information, and a purchase amount;
identify the prepaid account which is logically associated to the identified account key and the data contained in the user profile information;
deduct the purchase amount from a funds balance maintained for the prepaid account;
determine when a de-funding rule has become satisfied based on at least the schedule; and
respond to determining the de-funding rule has become satisfied, by returning at least some of funds balance remaining in the prepaid account back to the financial source identified by the funding source identification.

12. The payment processing system of claim 11, wherein the instructions further operate the processor to:
determine when the de-funding rule has become satisfied based on a current time of day and date being within a threshold of scheduled arrival of an aircraft flight identified based on the schedule, and wherein during the aircraft flight the prepaid account was available to the user to make on-board purchases.

13. The payment processing system of claim 11, wherein the instructions further operate the processor to:
determine the de-funding rule has become satisfied based on receiving a message indicating departure of an aircraft flight identified based on the schedule is delayed more than a defined time duration beyond a scheduled departure of the aircraft flight.

14. The payment processing system of claim 11, wherein the instructions further operate the processor to:
determine the de-funding rule has become satisfied based on receiving a message indicating indicating cancellation of an aircraft flight identified based on the schedule.

15. The payment processing system of claim 11, wherein the instructions further operate the processor to:
determine when the funding rule has become satisfied based on receiving a message indicating reestablishment of communication connectivity for at least a threshold duration between a ground station and a radio transceiver of an aircraft during an aircraft flight identified based on the schedule and further based on a current time of day and date being after a scheduled departure of an aircraft flight identified based on the schedule.

16. A vehicle-based prepaid account access system comprising:
a network interface;
a processor; and
a memory storing instructions executable by the processor to:
communicate through the network interface with a payment processing system offboard the vehicle to receive a set of prepaid account balances logically associated with account keys, wherein the payment processing system has logically associated the set of prepaid account balances and account keys with a corresponding set of user profile information, funding source identification, and schedule;
receive a transaction message from a user device onboard the vehicle requesting a purchase, the transaction message containing information identifying one of the account keys, data contained in the user profile information, and a purchase amount;
determine whether the purchase amount is greater than the prepaid account balance logically associated with the identified account key and the data contained in the user profile information;
responsive to when the purchase amount is determined to be greater than the prepaid account balance, send a declined transaction message indicating the purchase is declined;
responsive to when the purchase amount is determined to be less than the prepaid account balance, deduct the purchase amount from the prepaid account balance and send to the user device an accepted transaction message indicating the purchase is approved; and
responsive to when the prepaid account balance logically associated with an underfunded one of the account keys becomes less than a defined threshold, communicate a funding request message containing the underfunded one of the account keys through the network interface to the payment processing system.

17. The vehicle-based prepaid account access system of claim 16, wherein the instructions further operate the processor to:
determine when a funding rule has become satisfied based on at least a travel schedule of the vehicle; and
respond to determining the funding rule has become satisfied, by communicating through the network interface with the payment processing system offboard the vehicle to initiate funding of the prepaid account balances from the logically associated funding source identification.

18. The vehicle-based prepaid account access system of claim 17, wherein the instructions further operate the processor to:
determine the funding rule has become satisfied based on at least one of:
a current time of day and date being within a threshold time of a scheduled trip of the vehicle determined based on the schedule during which the prepaid account is available to make on-board purchases; and
receiving a message indicating loss of communication connectivity for at least a threshold duration between a ground station and a radio transceiver of the vehicle during the trip of the vehicle.

19. The vehicle-based prepaid account access system of claim 16, wherein the instructions further operate the processor to:
determine a de-funding rule has become satisfied based on at least a travel schedule of the vehicle determined based on the schedule; and
respond to determining the de-funding rule has become satisfied, by communicating through the network interface with the payment processing system offboard the vehicle to initiate return of at some of the prepaid account balance back to a financial source identified by the funding source identification.

20. The vehicle-based prepaid account access system of claim 19, wherein the instructions further operate the processor to:
determine the de-funding rule has become satisfied based on at least one of:
a current time of day and date being within a threshold time of an end of the travel schedule of the vehicle determined based on the schedule; and
receiving a message indicating reestablishment of communication connectivity for at least a threshold duration between a ground station and a radio transceiver of the vehicle during travel of the vehicle.
